(19) United States
(12) Patent Application Publication
(10) Pub. No.: US 2018/0265355 A1
(43) Pub. Date: Sep. 20, 2018

(54) ROBUST CATALYST FOR HYDROGEN PRODUCTION FROM P-FORMALDEHYDE

(71) Applicant: SABIC Global Technologies B.V., Bergen op Zoom (NL)

(72) Inventors: Khalid Al-Bahily, Thuwal (SA); Balamurugan Vidjayacoumar, Thuwal (SA); Sandro Gambarotta, Ottawa (CA); Nicholas P. Alderman, Ottawa (CA)

(21) Appl. No.: 15/757,510

(22) PCT Filed: Aug. 30, 2016
(86) PCT No.: PCT/IB2016/055175

§ 371 Date: Mar. 5, 2018

Related U.S. Application Data
(60) Provisional application No. 62/216,022, filed on Sep. 9, 2015.

(51) Int. Cl. C01B 3/22; B01J 27/13

(52) U.S. Cl. CPC C01B 3/22; B01J 27/13; C01B 2203/1041; C01B 2203/1211; B01J 2523/842; B01J 2523/17; B01J 2523/18; B01J 2523/821; B01J 2523/827; C01B 2203/1614

(57) ABSTRACT

Disclosed is a method of producing hydrogen from formaldehyde. The method includes mixing an aqueous base, formaldehyde, and a transition metal complex having a transition metal-halide bond to form a homogenous aqueous solution having a basic pH. The halide dissociates from the transition metal complex in response to the basic pH of the solution to produce hydrogen from the formaldehyde present in the homogeneous aqueous solution.

### CROSS REFERENCE TO RELATED APPLICATIONS

This application claims the benefit of priority of U.S. Provisional Patent Application No. 62/216,022, filed Sep. 9, 2015, which is hereby incorporated by reference in its entirety.

### BACKGROUND OF THE INVENTION

### A. Field of the Invention

The invention generally concerns a method for producing hydrogen gas from formaldehyde. In particular, an aqueous basic composition containing formaldehyde and transition metal complex having a coordination bond between a transition metal and a halide can be used to produce hydrogen.

### B. Description of Related Art

Conventional technology produces hydrogen from steam reforming of methane as shown in the equations (1) and (2) below. The major source of the methane is from natural gas.

CH₄+H₂O→CO+3H₂ (1)

CO+H₂O→CO₂+H₂ (2)

Due to the depletion of fossil fuels, there is a necessity to find the alternative feedstock to meet the growing demand for hydrogen production globally.

Alternative processes for hydrogen production have been proposed (for example, water-splitting, thermal dehydrogenation of formic acid, catalytic dehydrogenation of small organic molecules, thermal dehydrogenation of amino-boranes and the like). Dehydrogenation of small organic molecules such as formic acid and methanol has been attempted. Dehydrogenation of formic acid into hydrogen and carbon dioxide suffers in that the reaction is inefficient as formic acid has a low hydrogen content (about 4.4 wt. %). Further, the production of carbon dioxide can be problematic.

While there have been some attempts to use formaldehyde in hydrogen production processes, the processes typically require supported catalyst materials, metal oxide catalysts, or metal nanoparticle catalysts. Further, such processes require additional materials and/or use high temperatures, thereby making the processes inefficient and difficult to scale-up for mass hydrogen gas production. By way of example, Chinese Patent Application Publication No. 101862646 to Ji et al. describes the use of a supported magnetic copper and iron catalyst to produce hydrogen from formaldehyde. Li et al. in “Highly efficient hydrogen production from formaldehyde over Ag/γ-Al2O3 catalyst at room temperature”, International Journal of Hydrogen Energy, 2014, 39:9114-9120 describes a supported silver on gamma alumina catalyst for production of hydrogen from formaldehyde. Bi et al. in “Nano-Cu catalyze hydrogen production from formaldehyde solution at room temperature” International Journal of Hydrogen Energy, 2008, 33:2225-2232 describes the use of platinum, gold, nickel and copper nano-metal particles for the production of hydrogen from aqueous formaldehyde. International Patent Application Publication No. WO2015003680 to Heim et al. describes a ligand stabilized ruthenium catalyst (e.g., μ-chlorido,-μ-formiate,-μ-hydrido(p-cymene)ruthenium (II) dimer tetrafluoroborate salt) for the production of hydrogen from waste water contaminated with formaldehyde.

As discussed, the current attempts to produce hydrogen from formaldehyde have been largely inefficient. Such attempts have low hydrogen production capabilities, utilize heterogeneous catalytic systems, or require the use expensive catalysts or catalysts that are labor intensive to manufacture.

### SUMMARY OF THE INVENTION

A discovery has been made that provides a solution to the aforementioned problems and inefficiencies associated with the generation of hydrogen from small organic molecules such as formaldehyde. The discovery is premised on the use of a homogenous aqueous system that includes an aqueous basic solution having a transition metal halide catalyst and formaldehyde (e.g., para-formaldehyde) solubilized in the basic solution. Hydrogen gas can be produced directly from formaldehyde at mild reaction conditions (e.g., room temperature such as from 15° C. to 30° C., and most preferably from 20° C. to 25° C.). The system is oxygen-resilient, chemically robust, and energy efficient, thereby allowing for large scale hydrogen production to meet the ever increasing hydrogen gas demands of the chemical and petrochemical industries. In particular, the process of the present invention can (1) avoid the costs associated with conventional supported catalysts (2) be operated at reduced temperatures (e.g., room temperature conditions), (3) be a homogeneous catalytic system, and (4) can limit or avoid the production of by-products such as carbon dioxide. Without wishing to be bound by theory, it is believed that enhanced efficiency of the system is due to the fact that the H₂ evolution occurs in the homogeneous phase of the reaction mixture.

In one aspect of the present invention, a method of producing hydrogen from formaldehyde is disclosed. The method can include mixing an aqueous base, formaldehyde, and a transition metal complex having a transition metal-halide bond to form a homogenous aqueous solution having a basic pH and producing hydrogen (H₂) gas from the formaldehyde present in the homogeneous aqueous solution. The formaldehyde can be para-formaldehyde, hydrated formaldehyde, or a combination thereof. The molar ratio of formaldehyde to base can be equal to or less than 2:1, preferably equal to or less than 1.5:1, more preferably equal to or less than 1.2:1, even more preferably from 0.5:1 to 1.5:1, or most preferably from 1:1 to 1.3:1. Without wishing to be bound by theory, it is believed that a hydroxide ion replaces the halide to form a transition metal-hydroxyl bond, and the transition metal complex having the transition metal-hydroxyl bond reacts with the formaldehyde to produce H₂ gas. The transition metal can be iron (Fe), ruthenium (Ru), iridium (Ir), copper (Cu), or silver (Ag) and the halide can be fluorine (F), chlorine (Cl), bromine (Br), iodine (I), or astatine (At), preferably Cl. In some instances, the transition metal complex can be a Fe(II) complex, a Ru(III) complex, a Ir(III) complex, a Cu(I) complex, a Ag(I) complex, or any combination thereof. In a preferred embodiment, the catalyst can be FeCl₂, RuCl₃, IrCl₃, CuCl, AgCl, or any combination thereof. The pH is adjusted to a pH from 8 to 14, preferably 10 to 14, and most preferably 12 to 14 using an inorganic base (e.g., NaOH or KOH). Formic acid can also be produced and can be subsequently reacted to produce addition hydrogen and carbon dioxide. Conditions for the production of hydrogen can include a temperature of greater than 0° C. to less than 50° C., preferably from 10° C. to 40° C., more preferably from 15° C. to 30° C., and most preferably from 20° C. to 25° C.

In another aspect of the present invention, an aqueous composition capable of producing hydrogen (H₂) gas from formaldehyde is described. The composition can include formaldehyde, a transition metal complex having a transition metal-halide bond, and a base. The composition includes sufficient base to make the pH of the composition basic. The formaldehyde is preferably p-formaldehyde. The pH of the aqueous mixture can range from 8 to 14, preferably 10 to 14, and most preferably 12 to 14. The base can be a M(OH), where M is an alkali metal or an alkaline earth, preferably sodium hydroxide (NaOH). The molar ratio of formaldehyde to base can be equal to or less than 2:1, preferably equal to or less than 1.5:1, more preferably equal to or less than 1.2:1, even more preferably from 0.5:1 to 1.5:1, or most preferably from 1:1 to 1.3:1. The transition metal complex having a transition metal-halide bond can be homogenously present in the aqueous composition. Said another way, a transition metal complex having a transition metal-halide bond can be partially or fully solubilized in the aqueous composition. The a transition metal complex having a transition metal-halide bond can be an Fe(II), a Ru(III) complex, a Ir(III) complex, a Cu(I) complex, a Ag(I) complex, or any combination thereof containing catalyst. In a preferred embodiment, the catalyst can be FeCl₂, RuCl₃, IrCl₃, CuCl, AgCl, or any combination thereof. In some embodiments, formic acid can be produced and hydrogen gas is further produced from the formic acid. The temperature of the aqueous mixture can range from greater than 0° C. to less than 50° C., preferably from 10° C. to 40° C., more preferably from 15° C. to 30° C., and most preferably from 20° C. to 25° C.

Also disclosed in the context of the present invention are embodiments 1-29. Embodiment 1 is a method of producing hydrogen from formaldehyde, the method comprising: (a) mixing an aqueous base, formaldehyde, and a transition metal complex having a transition metal-halide bond to form a homogenous aqueous solution having a basic pH; and (b) producing hydrogen (H₂) gas from the formaldehyde present in the homogeneous aqueous solution. Embodiment 2 is the method of embodiment 1, wherein the molar ratio of formaldehyde to base is equal to or less than 2:1, preferably equal to or less than 1.5:1, more preferably equal to or less than 1.2:1, even more preferably from 0.5:1 to 1.5:1, or most preferably from 1:1 to 1.3:1. Embodiment 3 is the method of any one of embodiments 1 to 2, wherein the formaldehyde is para-formaldehyde, hydrated formaldehyde, or a combination thereof. Embodiment 4 is the method of any one of embodiments 1 to 3, wherein a hydroxide ion replaces the halide to form a transition metal-hydroxyl bond, and wherein the transition metal complex having the transition metal-hydroxyl bond reacts with the formaldehyde to produce H₂ gas. Embodiment 5 is the method of any one of embodiments 1 to 4, wherein the halide is fluorine (F), chlorine (Cl), bromine (Br), iodine (I), or astatine (At), preferably Cl. Embodiment 6 is the method of embodiment 5, wherein the transition metal is iron (Fe), ruthenium (Ru), iridium (Ir), copper (Cu), or silver (Ag). Embodiment 7 is the method of embodiment 6, wherein the transition metal complex is an Fe complex, preferably an Fe(II) complex. Embodiment 8 is the method of embodiment 6, wherein the transition metal complex is a Ru complex, preferably a Ru(III) complex. Embodiment 9 is the method of embodiment 6, wherein the transition metal complex is a Ir complex, preferably an Ir(III) complex. Embodiment 10 is the method of embodiment 6, wherein the transition metal complex is a Cu complex, preferably an Cu(I) complex. Embodiment 11 is the method of embodiment 6, wherein the transition metal complex is a Ag complex, preferably a Ag(I) complex. Embodiment 12 is the method of any one of embodiments 1 to 11, wherein the base is NaOH. Embodiment 13 is the method of any one of embodiments 1 to 12, wherein the mixture has a pH from 8 to 14, preferably 10 to 14, and most preferably 12 to 14. Embodiment 14 is the method of any one of embodiments 1 to 13, wherein the method further produces formic acid, and wherein H₂ gas is further produced from the formic acid. Embodiment 15 is the method of any one of embodiments 1 to 14, wherein the temperature of the mixture in step (b) ranges from greater than 0° C. to less than 50° C., preferably from 10° C. to 40° C., more preferably from 15° C. to 30° C., and most preferably from 20° C. to 25° C. Embodiment 16 is the method of any one of embodiments 1 to 15, wherein an external bias is not used to produce H₂ gas.

Embodiment 17 is a homogeneous aqueous solution having a basic pH and capable of producing hydrogen (H₂) gas from formaldehyde, the solution comprising an aqueous base, formaldehyde, and a transition metal complex having a transition metal-halide bond and/or a transition metal complex having a transition metal-hydroxyl bond. Embodiment 18 is the aqueous solution of embodiment 17, wherein the molar ratio of formaldehyde to base is equal to or less than 2:1, preferably equal to or less than 1.5:1, more preferably equal to or less than 1.2:1, even more preferably from 0.5:1 to 1.5:1, or most preferably from 1:1 to 1.3:1. Embodiment 19 is the aqueous solution of any one of embodiments 17 to 18, wherein the formaldehyde is para-formaldehyde, hydrated formaldehyde, or a combination thereof. Embodiment 20 is the aqueous solution of any one of embodiments 17 to 19, wherein the halide is Fluorine (F), Chlorine (Cl), Bromine (Br), Iodine (I), or Astatine (At), preferably Cl. Embodiment 21 is the aqueous solution of embodiment method of claim 20, wherein the transition metal is iron (Fe), Ruthenium (Ru), Iridium (Ir), Copper (Cu), or Silver (Ag). Embodiment 22 is the aqueous solution of embodiment 21, wherein the transition metal complex is an Fe complex, preferably an Fe(II) complex. Embodiment 23 is the aqueous solution of embodiment 21, wherein the transition metal complex is a Ru complex, preferably a Ru(III) complex. Embodiment 24 is the aqueous solution of embodiment 21, wherein the transition metal complex is a Ir complex, preferably an Ir(III) complex. Embodiment 25 is the aqueous solution of embodiment 21, wherein the transition metal complex is a Cu complex, preferably an Cu(I) complex. Embodiment 26 is the aqueous solution of embodiment 21, wherein the transition metal complex is a Ag complex, preferably a Ag(I) complex. Embodiment 27 is the aqueous solution of any one of claims 18 to 26, wherein the base is NaOH. Embodiment 28 is the aqueous solution of any one of embodiments 18 to 27, wherein the mixture has a pH from 8 to 14, preferably, 10 to 14, and most preferably 12 to 14. Embodiment 29 is the aqueous solution of any one of embodiments 18 to 28, wherein the temperature of the solution ranges from greater than 0° C. to less than 50° C., preferably from 10° C. to 40° C., more preferably from 15° C. to 30° C., and most preferably from 20° C. to 25° C.

The following includes definitions of various terms and phrases used throughout this specification.

The term “homogeneous” is defined as a reaction equilibrium in which the catalyst(s), reactants, and products are all or substantially all in the same phase (e.g., the catalysts, reactants and products are dissolved or substantially dissolved in the basic aqueous medium).

“Formaldehyde” as used herein includes gaseous, liquid and solid forms of formaldehyde. “Formaldehyde” includes its aldehyde form (CH₂O), its hydrated form (methanediol), and its para-formaldehyde form of

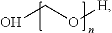

where n can be up to 100.

The “turn over number” or TON,” as used herein, means the number of moles of substrate that a mole of catalyst converts in the timeframe of the experiment or before being deactivated. TON is calculated as the number of millimoles of formaldehyde, divided by the number of moles of catalyst unless otherwise indicated.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the catalysts of the present invention are their abilities to catalyze hydrogen production from formaldehyde.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of an embodiment of a reaction system of the present invention.

FIG. 2 depicts graphs of the amount of hydrogen formed over time using a RuCl₃ catalyst of the present invention.

FIG. 3 depicts graphs of the amount of hydrogen formed over time using a IrCl₃ catalyst of the present invention.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

The present invention provides for an efficient and scalable process for producing hydrogen gas from formaldehyde. The process includes mixing an homogeneous aqueous basic solution having a transition metal catalyst (e.g., a transition metal catalyst having a metal-halide bond), formaldehyde (e.g., methanediol or para-formaldehyde or a combination thereof), and a base and producing hydrogen gas from the formaldehyde. As illustrated in non-limiting embodiments in the examples, this process can have large turn-over numbers, be operated at relatively low temperatures (e.g., room temperatures such as 15° C. to 30° C., preferably from 20° C. to 25° C.) and under a variety of conditions, thereby allowing for the efficient and scalable production of hydrogen gas. In certain instances, production of unwanted by-products such as carbon dioxide can be avoided.

These and other non-limiting aspects of the present invention are discussed in further detail in the following sections.

### A. Transition Metal Complex Catalyst

In some instances, a transition metal complex having a coordination bond between the transition metal and a leaving group acts as a catalyst for the production of hydrogen (H₂) and, in some cases formate, from formaldehyde. The transition metal complex can undergo a reversible dissociation reaction of at least one leaving group. Without wishing to be bound by theory, it is believed that the dissociation of at least one leaving group can produce a transient electrophilic species. A non-limiting example of a transition metal complex catalyst undergoing a dissociation reaction is shown in equation (3) below:

[M^{a}(Zₙ)^{b}(Lₒ)^{x}]^{y}↔[M^{a}(Zₙ)^{b}]^{y}+(Lₒ)^{x} (3)

where M is a transition metal having a charge a, Z is one or more ligands bonded to the metal with a total charge of b, L is one or more leaving group with total charge of x, and a is a positive integer from 0 to 6, preferably 0 to 3, b is an negative integer from 0 to −5, x is a negative integer from −1 to −2, y is the total charge of the transition metal complex, and n and o are the atomic ratio relative to M, where n ranges from 0 to 6 and o ranges from 1 to 3. In some instances y is 0, −1, −2, −3, −4, −5, or −6.

The transition metal complex can react with nucleophiles in the reaction mixture, for example, hydroxide ion as shown in equation (4) below.

[(M)^{a}(Zₙ)^{b}(Lₒ)^{x}]^{y}+(OH⁻)ₚ↔[(M)^{a}(Zₙ)^{b}(OH⁻)ₚ]^{y} (4)

where M is a transition metal having a charge a, Z is one or more ligands bonded to the metal with a total charge of b, L is one or more leaving group with total charge of x, and a is a positive integer from 0 to 6, preferably 0 to 3, b is an negative integer from 0 to −5, x is a negative integer from −1 to −2, y is the total charge of the transition metal complex, and n, o, and p are the atomic ratio relative to M, where n is ranges from 0 to 6, o ranges from 1 to 3, and p ranges from 0 to 1. In some instances, y is 0, −1, −2, −3, −4, −5, or −6.

Without wishing to be bound by theory, it is believed that the [(M)^{a}(Zₙ)^{b}(OH⁻)ₚ]^{y} species can react with small organic molecules (e.g., formaldehyde in either intact or hydrated form), followed by reductive elimination of hydrogen and consequent formation of the formate anion as shown in reaction pathway (A) below. Alternatively, the partly deprotonated form of methanediol (CH₂(OH)₂), as obtained from the attack of hydroxide ion to p-formaldehyde, may also directly coordinate to the [(M)^{a}(Zₙ)^{b} (OH⁻)ₚ]^{y} intermediate to form the same species.

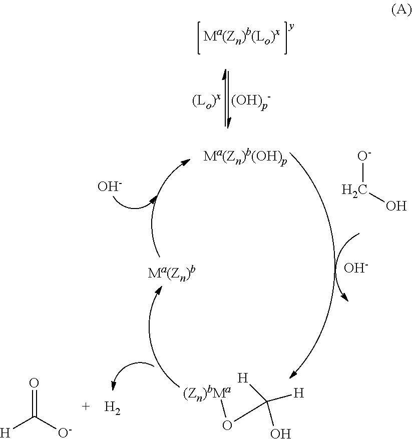

where M is a transition metal having a charge a, Z is one or more ligands bonded to the metal with a total charge of b, L is one or more leaving group with total charge of x, and a is a positive integer from 0 to 6, or 0, 1, 2, 3, 4, 5, 6, preferably 0 to 3, b is an negative integer from 0 to −5, or 0, −1, −2, −3, −4, −5, x is a negative integer from −1 to −2, y is the total charge of the transition metal complex, and n, o, and p are the atomic ratio relative to M, where n is ranges from 0 to 6, or 0, 1, 2, 3, 4, 5, 6, o ranges from 1 to 3, or 1, 2, or 3, and p ranges from 0 to 1. In some instances y is 0, −1, −2, −3, −4, −5, or −6. In a preferred instance y is 0.

The transition metal in the transition metal complex catalyst can be iron (Fe), ruthenium (Ru), rhodium (Rh), iridium (Ir), copper (Cu), or silver (Ag), zinc (Zn) or any combination thereof. Preferably, the transition metal is Fe(II), Ru(III), Ir(III), Cu(I), or Ag(I). In some instances, at least one of leaving groups (Lₒ) can include a halide. Non-limiting examples of halides including fluorine (F), chlorine (Cl), bromine (Br), iodine (I), or astatine (At), preferably, chlorine (Cl). Ligand Z can be the same or different than leaving group L. In some embodiments, Z can be an inorganic ligand, an organic ligand or a combination thereof. Non-limiting examples of organic groups include aromatic groups, a cyano group, a substituted cyano group, acetate thiocyanate, aminidate, nitrate, or combinations thereof. Non-limiting examples of inorganic groups include a halide, phosphate, or both. In some complexes Z is not necessary (e.g., when M has a charge of +1). In a preferred instance, the transition metal complex is a metal halide (e.g. a transition metal complex having the structure MZL, where Z and L are both halides).

### B. Reactants and Medium for Production of Formate and Hydrogen

1. Reactants

The reactants in the step of producing formate and H₂ can include formaldehyde, paraformaldehyde, or other organic molecules that release formaldehyde in aqueous solution. Formaldehyde can be formaldehyde, aqueous formaldehyde solutions (for example 37% in water), para-formaldehyde, or combinations thereof. para-Formaldehyde is the polymerization of formaldehyde with a typical degree of polymerization of 1 to up to 100 units. Aqueous formaldehyde (methanediol) and para-formaldehyde are available from many commercial manufacturers, for example, Sigma Aldrich® (USA). The basic reagent can include a metal hydroxide (MOH or M(OH)₂), where M is an alkali or alkaline earth metal. Non-limiting examples of alkali or alkaline earth metals include lithium, sodium, potassium, magnesium, calcium, and barium. In a preferred embodiment, the base is sodium hydroxide (NaOH). The molar ratio of small organic molecule (e.g., formaldehyde) to base is equal to or less than 2:1, 1.9:1, 1.8:1, 1.7:1, 1.6:1, 1.5:1, 1.2:1, 1.1:1, 1:1, 0.5:1 or any range there between.

2. Medium

The production of formate and hydrogen from formaldehyde can be performed in any type of medium that can solubilize the catalyst and reagents. In a preferred embodiment, the medium is water. Non-limiting examples of water include de-ionized water, salt water, river water, canal water, city canal water or the like.

### C. Generation of Hydrogen

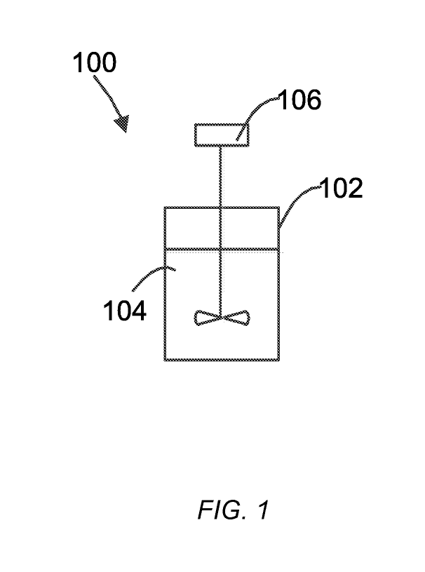

As illustrated in the Examples section, hydrogen can be produced by mixing an aqueous composition having a basic pH, formaldehyde, and a transition metal complex catalyst. In preferred instances, the catalyst and the formaldehyde are partially or fully solubilized within the aqueous composition. FIG. 1 is a schematic of an embodiment of a reaction system 100 for producing formate and hydrogen from formaldehyde. System 100 is particularly suited to methods that use a transition metal complex catalyst having a leaving group that dissociates from the transition metal complex in response to basic pH. System 100 includes container 102, aqueous mixture 104, and mixer 106. Container 102 can be transparent, translucent, or opaque. The aqueous homogeneous mixture 104 includes the aqueous formaldehyde (methanediol), a transition metal complex catalyst, and a base described throughout the specification. Mixer 106 can agitate the mixture to assist in dissolution of the formaldehyde, transition metal catalyst, and base. The transition metal complex catalyst can be used to catalyze the production of formate and hydrogen from the formaldehyde as shown in reaction pathway (A) above. When equimolar solutions of p-formaldehyde and sodium hydroxide are combined, a slow Cannizzaro's disproportionation to MeOH and (HCOO)Na can occur as shown in equation (5) below. The addition of a catalytic amount of the transition metal catalyst of the present invention does not appear to inhibit this disproportionation.

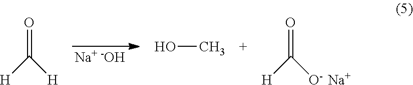

The production of formate (e.g., sodium formate) can be as illustrated in the reaction pathway (A) above and equation (6) below.

CH₂O(l)+NaOH(aq)→H₂(g)+HCOONa(aq) ΔGf⁰=−91 kJ/mol (6)

Without wishing to be bound by the theory, the production of hydrogen is in the homogeneous phase of the aqueous mixture. The spent transition metal complex (e.g., (M)^{a}(Zₙ)^{b}) can precipitate, or be precipitated, from the solution by addition of acid to increase the pH of the solution. The resulting precipitate can be removed, or substantially removed, through known solid/liquid filtration methods (e.g., centrifugation, filtration, gravity settling, etc.). In some embodiments, the transition metal complex is not removed or is partially removed from the solution. The formate (or formic acid), which is also dissolved in the solution, can then be used as a carbon source for production of other compounds (e.g., oxalate and/or monoethylene glycol.

Notably, and in one non-limiting embodiment, no carbon dioxide is formed during the production of hydrogen and, optionally formate. Thus, the process can be considered a “green” process. Furthermore, system 100 does not require the use of an external bias or voltage source, although one can be used if so desired. Further, the efficiency of system 100 allows for one to use formaldehyde as a hydrogen storage agent and formate as a carbon source for homologation reactions.

### D. Methanol Feedstock for Production of Monoethylene Glycol

In some instances, methanol can be used as a feedstock for the production of hydrogen. Methanol can be oxidized to form formaldehyde by, for example, the Formox® (Formox AB, Sweden) process. In this process, methanol and oxygen react in the presence of a catalyst such as silver metal or a mixture of an iron oxide with molybdenum and/or vanadium to form formaldehyde. When the catalyst is a mixture of iron oxide with molybdenum and/or vanadium, methanol and oxygen react at about 300 to 400° C., or 325 to 375° C., or 330° C. to 360° C., or any value there between to produce formaldehyde according to equation (19) below:

CH₃OH+½O₂→CH₂O+H₂O (19)

The formaldehyde can then be used as described above in the production of hydrogen

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### Materials and Testing Procedures for Production of Hydrogen from Formaldehyde

Materials.

Paraformaldehyde, 37% formaldehyde solution, and sodium ferrocyanide decahydrate, acetamide were purchased from Sigma-Aldrich® (USA). Formic acid was purchased from Acros Organics (BELGIUM). Ruthenium chloride (RuCl3) and iridium chloride (IrCl₃) were purchased from Sigma-Aldrich® (USA). Sodium thiosulfate was purchased from Oakwood Chemicals (USA). Iodine was purchased from Strem Chemicals, Inc. (USA). Citric acid was purchased from Fisher Scientific (USA). Acetic anhydride was purchased from VWR International (USA). Chemicals were used without further purification. If not specifically mentioned, all reactions were carried out in distilled water without degassing or other modifications.

Analytical Equipment.

pH measurements were taken with a Hanna HI 2210 benchtop pH meter with a general purpose combination pH electrode, both purchased from Sigma-Aldrich®. Powder XRD diffractograms were obtained on a Rigaku Ultima IV diffractometer set to 2 2θo/min from 10-70 2θo. UV-Vis spectra were obtained on a Specmate UV-1100 spectrometer. Infrared spectra were obtained on a Nicolet 6700 FTIR with diamond ATR between 650-4000 cm⁻¹, at 128 scans with a resolution of 4 cm⁻¹.

Product Analysis.

H_{z}, CO₂, CO and O₂ gas identification and detection was carried out with an Agilent 7820A GC equipped with a thermal conductivity detector (TCD), using an Agilent GS-CarbonPlot column (for CO₂) or Agilent HP-Molesieve column (for all other gasses).

Determination of Reaction Kinetics.

The gaseous outflow of the reaction mixture was hooked up to a Restek ProFLOW 6000 Electronic Flow-meter connected to a computer.

Determination of Formate Concentration.

Concentration of dissolved formate was determined according to a modified colorimetric procedure by Sleat et al. (Appl. Environ. Microbiol. 1984, 47, 884). An aliquot of the reaction mixture (0.5 mL) was added to acetamide (10%, 2 mL) and citric acid (0.05%) dissolved in a 1:1 mixture of isopropanol and water. To the test mixture, sodium acetate (0.1 mL of 30%) and of acetic anhydride (7 mL) were added. The test mixture was shaken and incubated at room temperature for 60 minutes and measured spectrophotometrically at 510 nm. The concentration was determined against a standard curve.

Determination of Formaldehyde Concentration.

Formaldehyde concentrations were determined through iodine/sodium thiosulfate titrations. To an aliquot of the reaction mixture (10 mL), de-ionized water (20 mL), iodine (25 mL, 0.05M/L in methanol) and sodium hydroxide (10 mL, 1.0 M) were added and stirred for 10 minutes followed by the addition of sulfuric acid (15 mL, 1.0 M). The sample solution was then titrated with sodium thiosulphate, with addition of a 1% starch solution as an indicator once the solution turned light yellow. The concentration of formaldehyde was then calculated by a standard curve.

### Example 2

### Generation of Hydrogen from Para-Formaldehyde-RuCl₃ Catalyst

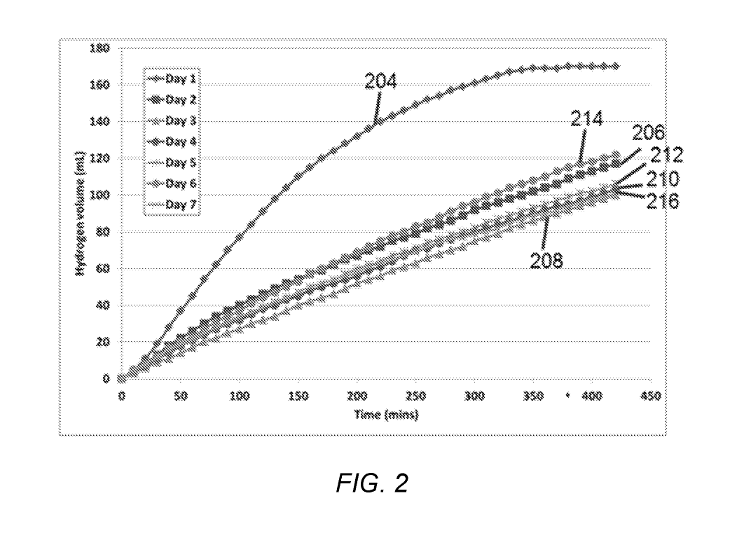

Formaldehyde (2 g, of p-formaldehyde or 37% formaldehyde solutions) was added to NaOH (3 g) in H₂O. The transition metal catalyst, RuCl₃ (1.33 mmoles) was added to the solution. The reaction mixture was stirred at room temperature for seven (7) days with additions of formaldehyde (2 g) and sodium hydroxide (3 g) each day. On each day, hydrogen generation was determined over a period of 0 to 450 minutes. FIG. 2 are graphs of hydrogen production versus time for 7 days. Data lines 202-214 represent data for days 1-7, respectively. As shown in FIG. 2, the transition metal complex with a metal-halide bond was effective at dehydrogenating formaldehyde to produce hydrogen. Specifically, the most hydrogen (greater than 160 mL) was generated day 1, with days 2-7 producing about the same amount of hydrogen.

### Example 3

### Generation of Hydrogen from Para-Formaldehyde-RuCl₃ Catalyst

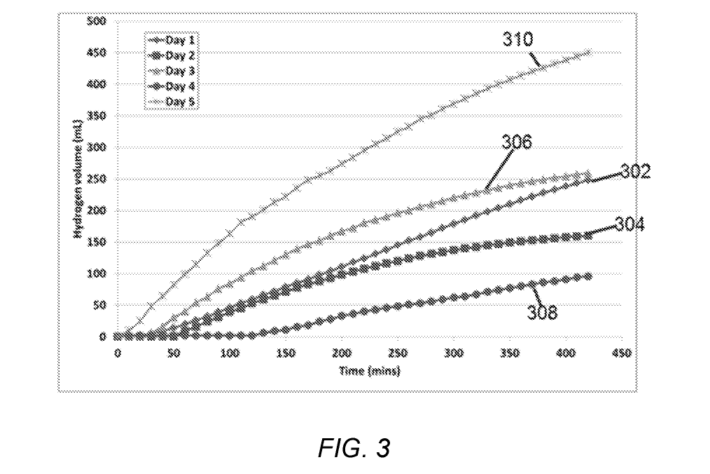

Formaldehyde (2 g, of p-formaldehyde or 37% formaldehyde solutions) was added to NaOH (3 g) in H₂O. The transition metal catalyst, IrCl₃ (0.66 mmoles) was added to the solution. The reaction mixture was stirred at room temperature for five (5) days with additions of formaldehyde (2 g) and sodium hydroxide (3 g) each day. On each day, hydrogen generation was determined over a period of 0 to 450 minutes. FIG. 3 are graphs of hydrogen production versus time for 5 days. Data lines 302-310 represent data for days 1-5, respectively. As shown in FIG. 3, the transition metal complex with a metal-halide bond was effective at dehydrogenating formaldehyde to produce hydrogen.

1. A method of producing hydrogen from formaldehyde, the method comprising:
(a) mixing an aqueous base, formaldehyde, and a transition metal complex having a transition metal-halide bond to form a homogenous aqueous solution having a basic pH; and
(b) producing hydrogen (H₂) gas from the formaldehyde present in the homogeneous aqueous solution at a temperature from greater than 0° C. to less than 50° C.

2. The method of claim 1, wherein the molar ratio of formaldehyde to base is equal to or less than 2:1.

3. The method of claim 1, wherein the formaldehyde is para-formaldehyde, hydrated formaldehyde, or a combination thereof.

4. The method of claim 1, wherein the base is NaOH and the transition metal complex reacts with the OH⁻ of the NaOH to form a transition metal complex having a transition metal-hydroxyl bond, and wherein the transition metal complex having the transition metal-hydroxyl bond reacts with the formaldehyde to produce H₂ gas.

5. The method of claim 1, wherein the halide is fluorine (F), chlorine (Cl), bromine (Br), iodine (I), or astatine (At), preferably Cl.

6. The method of claim 1, wherein the transition metal is iron (Fe), ruthenium (Ru), iridium (Ir), copper (Cu), or silver (Ag).

7. The method of claim 1, wherein the transition metal complex is an Fe complex, a Ru complex an Ir complex, a Cu complex, or an Ag complex.

8. The method of claim 1, wherein the base is NaOH.

9. The method of claim 1, wherein the mixture has a pH from 8 to 14.

10. The method of claim 1, wherein the method further produces formic acid, and wherein H₂ gas is further produced from the formic acid.

11. The method of claim 1, wherein the temperature of the mixture in step (b) ranges from 10° C. to 40° C.

12. The method of claim 1, wherein an external bias is not used to produce H₂ gas.

13. A homogeneous aqueous solution having a basic pH, the solution comprising an aqueous base, formaldehyde, and a transition metal complex having a transition metal-halide bond wherein the temperature of the solution ranges from greater than 0° C. to less than 50° C.

14. The aqueous solution of claim 13, wherein the molar ratio of formaldehyde to base is equal to or less than 2:1.

15. The aqueous solution of claim 13, wherein the formaldehyde is para-formaldehyde, hydrated formaldehyde, or a combination thereof.

16. The aqueous solution of claim 13, wherein the halide is fluorine (F), chlorine (Cl), bromine (Br), iodine (I), or astatine (At), preferably Cl.

17. The aqueous solution of claim 13, wherein the transition metal is iron (Fe), ruthenium (Ru), iridium (Ir), copper (Cu), or silver (Ag).

18. The aqueous solution of claim 13, wherein the transition metal complex is an Fe complex, a Ru complex, a Ir complex, a Cu complex, or an Ag complex.

19. The aqueous solution of claim 13, wherein the base is NaOH, and wherein the mixture has a pH from 8 to 14.

20. The aqueous solution of claim 13, wherein the temperature of the solution is from 10° C. to 40° C.
